(19) United States
(12) Patent Application Publication
(10) Pub. No.: US 2022/0185034 A1
(43) Pub. Date: Jun. 16, 2022

(54) TIRE WITH IMPROVED BEAD STRUCTURE

(71) Applicant: The Goodyear Tire & Rubber Company, Akron, OH (US)

(72) Inventor: Kiyoshi Ueyoko, Copley, OH (US)

(21) Appl. No.: 17/124,009

(22) Filed: Dec. 16, 2020

(51) Int. Cl. B60C 15/04; B60C 15/06

(52) U.S. Cl. CPC B60C 15/04; B60C 2015/046; B60C 2015/042; B60C 15/0603

(57) ABSTRACT

A pneumatic radial tire having a bead portion provided therein with a bead core, and a first layer of a plurality of sheath wires surrounding the bead core, and a second layer formed of a plurality of sheath wires surrounding the first layer, wherein the second layer of shear wires has a diameter less than the sheath wires of the first layer.

### FIELD OF THE INVENTION

The invention relates in general to pneumatic tires, and more particularly to a bead construction for heavy duty vehicles such as aircraft or trucks.

### BACKGROUND OF THE INVENTION

Annular tensile members, commonly referred to as tire bead cores, are designed to securely hold the tire on the rim during use. The tire beads provide a radially inner portion between the bead core and the rim that is radially compressed, and as this portion is compressed, the bead core is placed in tension. Radial compression occurs as the tire is mounted on a tapered rim seat by the action of the internal pressure of the tire pushing the bead axially outwardly toward the vertical bead flange.

Recently, attempts have been made to provide a heavy duty bead construction that has a reduced weight. However, problems have occurred such as creep under load and fretting. In creep under load, the synthetic cables or cords will stretch under load and as the plastic flows, the restraining force actually will lower with time. A second problem is fretting, which is when brittle fractures occur if the cords are placed in compression. Thus, an improved bead design which is light weight without sacrificing strength is desired, and that further overcomes the disadvantages mentioned above.

### SUMMARY OF THE INVENTION

The invention provides in a first aspect a pneumatic radial tire having a bead portion provided therein with a bead core, and a first layer of a plurality of sheath wires surrounding the bead core, and a second layer formed of a plurality of sheath wires surrounding the first layer, wherein the second layer of shear wires has a diameter less than the sheath wires of the first layer.

### Definitions

“About” means, unless otherwise specified, +/−10%.

“Aspect Ratio” means the ratio of a tire's section height to its section width.

“Axial” and “axially” mean the lines or directions that are parallel to the axis of rotation of the tire.

“Bead” or “Bead Core” mean generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions perpendicular to the axial direction within + or −5 degrees.

“Cord” means one of the reinforcement strands, including fibers, which are used to reinforce the plies.

“Extensible” means a cord having a relative elongation at break of greater than 0.2% at 10% of the breaking load, when measured from a cord extracted from a cured tire. The tensile measurements for elongation at break (total elongation in %) are performed in accordance with ISO 6892-1B(2019) at preload no more than 25 mpa tested on a cable or cord when taken from a cured tire.

“Flipper” means a reinforced fabric wrapped about the bead core.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Rib” means a circumferentially extending strip of rubber of the tread which is defined by at least one circumferential groove and either a second circumferential groove or a lateral edge, wherein the strip is not divided by full depth grooves.

### BRIEF DESCRIPTION OF THE DRAWINGS

The invention will be described by way of example and with reference to the accompanying drawings in which:

FIG. 1 is a cross-sectional view of one half of a radial ply tire;

FIG. 2 is a close-up view of the lower sidewall and bead portion of the tire of FIG. 1;

FIG. 3 is a cross-sectional view of the bead core of the tire of FIG. 1;

FIG. 4 is a cross-sectional view of a second embodiment of a bead core of the present invention;

FIG. 5 is a cross-sectional view of a third embodiment of a bead core of the present invention; and

FIG. 6 is a cross-sectional view of a fourth embodiment of a bead core of the present invention.

### DETAILED DESCRIPTION OF THE INVENTION

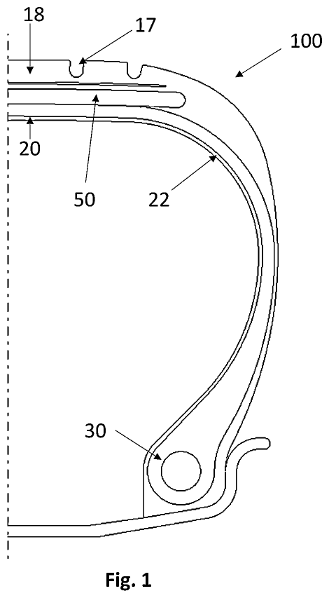

With reference to FIG. 1, a cross-sectional view of one half of a radial ply tire 100 is shown. The tire 100, as illustrated, is a construction for use as an aircraft tire. The tire 100 by way of example is a radial aircraft tire exposed to high internal pressures and tremendous loads. Other such tires such as earthmover, truck and farm tires are also ideally suited for using the bead core of the present invention.

The tire 100 is a radial ply tire having air imperious inner liner 22 which contains fluid or air under pressure. Radially outward of the inner liner 22 are one or more radial plies 20. Each ply 20 extends from an annular tensile member commonly referred to as a bead core 30. As shown the plies 20 are anchored about the bead core 30 either turning axially out and up forming a ply turnup or alternately turning axially in and under the bead core 30. Radially above the bead core 30 is an optional rubber apex 40.

Radially outward of the carcass plies 20 is a belt package 50 comprising a plurality of belt reinforcing layers, each layer is reinforced with parallel reinforcement cords. A top belt layer 53 is shown radially outward of the belt layers 50. Above the belt is a tread 18 as shown, the tread 18 has a plurality of optional circumferentially continuous grooves 17. The tire structure 100 as mentioned is an example of one type of tire structures that can utilize the bead core 30 of the present invention. Although the tire 100 as shown is an aircraft tire structure, the invention is usable in any highly loaded heavy-duty tire structure.

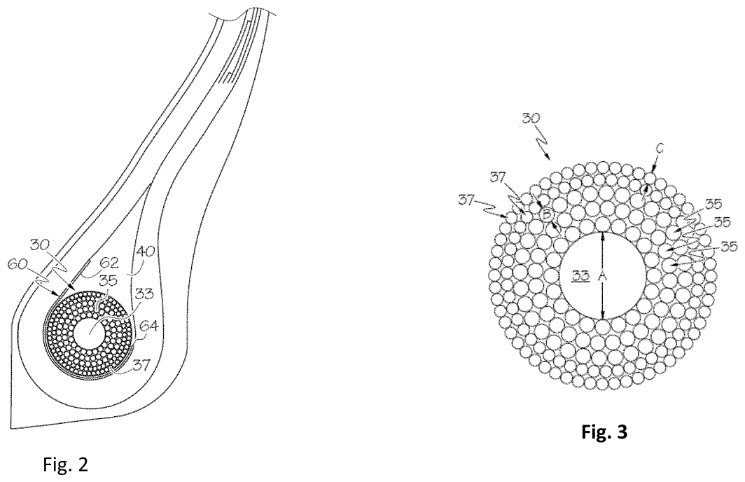

With reference to FIG. 2, a close up view of the lower sidewall and bead core 30 of the present invention is shown. As illustrated, the central core 33 is shown may optionally be a single wire or rod wound at 360 degree, wherein the ends of the wire are secured together to form one continuous hoop or central core 33. The central core 33 preferably has a diameter in the range of 3 mm to 20 mm, and more preferably in the range of 5 to 15 mm. As shown in FIG. 3, the cross-sectional shape of the central core is a solid circle. As shown in FIG. 3, the central core 33 is preferably made of an alloy of aluminum, or other lightweight metal alloy such as magnesium, titanium, or any metal alloy having a weight less than steel. Preferably if a metal central core is used, it is made of Aluminum or an aluminum alloy which has superb strength ratios while maintaining excellent ductility. The central core may also be made of a nonmetal material such aramid, carbon fiber, or plastic resin.

As further illustrated, the central core 33 is wrapped by a first annular row of inner sheath wires 35. Preferably, there is at least two annular rows of inner sheath wires 35, wherein each inner sheath wire has a. diameter B. Preferably, the diameter of the wires of the inner sheath wires 35 are the same, and range in size from 1.5 mm to about 3 mm, and more preferably, in the range of 1.8 mm to about 2.5 mm. Preferably, there are three to four annular rows of inner sheath wires 35. The wires 35 of the sheath layers are steel that are helically or spirally wound about the central core 33.

The bead core 30 further includes one or more annular rows of outer sheath layers 37. The wires in the outer annular row have a smaller diameter C than the diameter B of the wires in the inner sheath layers. Preferably, the diameter C of the wires of the outer sheath layer 37 are the same, and range in size from 1.5 mm to about 2.5 mm, and more preferably, in the range of 1. mm to about 2. mm.

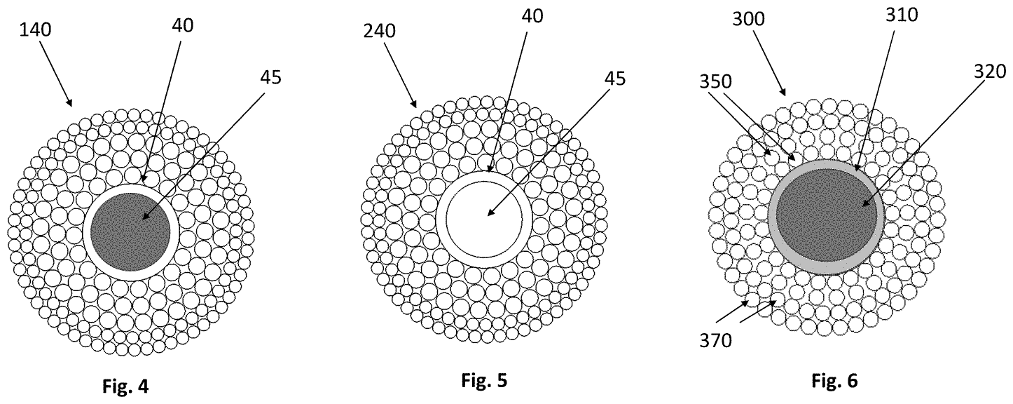

FIG. 4 illustrates a second embodiment of a bead core 140 of the present invention. The second embodiment is the same as FIG. 3, except for the following differences. The central core 40 has a cross-sectional shape of an annular tube 40, wherein the interior portion 45 of the annular tube is filled with a filler. The annular tube 40 may be metal, aramid, nylon, carbon fiber or plastic. The metal is preferably aluminum or steel. The filler may be metal, plastic, carbon fiber or plastic. As shown in FIG. 5, a third embodiment of a bead core 240 is shown, which is the same as the bead core of FIG. 5 except for the following differences. The interior portion 45 of the central core is filled with air (ie, its empty except for air).

FIG. 6 illustrates a fourth embodiment of a bead core 300 of the present invention. The central core 310 is formed of an annular tube, wherein the interior of the tube 320 may be filled with a filler or unfilled (with air). The annular tube 310 may be metal, aramid, nylon, carbon fiber or plastic. The metal is preferably aluminum or steel. The filler may be metal, plastic, carbon fiber or aramid. In this embodiment there are one or more inner rows 350 of annular wires having the same diameter. Preferably, the diameter of the wires of the inner row are the same, and range in size from 1.5 mm to about 3 mm, and more preferably, in the range of 1.8 mm to about 2.5 mm. The bead core 300 further has one or more radially outer rows 370 of larger diameter wires, wherein the range of the diameters range from 2 to 3 mm.

The entire bead is coated in an adhesive rubber layer and then a textile ply cord is helically wrapped around the bead cord.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic radial tire having a bead portion provided therein with a bead core, and a first annular layer of a plurality of sheath wires surrounding the bead core, and a second annular layer formed of a plurality of sheath wires surrounding the first layer, wherein the second layer of shear wires has a diameter less than the sheath wires of the first layer.

2. The pneumatic radial tire of claim 1 wherein the diameter of the sheath wires of the first layer is in the range of 1.5 mm to 3.0 mm.

3. The pneumatic radial tire of claim 1 wherein the diameter of the sheath wires of the second layer is in the range of 1 mm to 2 mm.

4. The pneumatic radial tire of claim 1 wherein the cross-sectional shape of the bead core is an annulus.

5. The pneumatic radial tire of claim 1 wherein the cross-sectional shape of the bead core is a circle.

6. The pneumatic radial tire of claim 1 wherein the bead core is selected from the group of titanium, aluminum, magnesium, or other metal alloy.

7. The pneumatic radial tire of claim 1 wherein the bead core is selected from the group of aramid, carbon fiber, plastic or other nonmetal material.

8. The pneumatic radial tire of claim 4 wherein an interior of the annulus is filled with a metal, nonmetal, aramid, carbon fiber or plastic filler.

9. The pneumatic radial tire of claim 4 wherein an interior of the annulus is filled air.

10. The pneumatic radial tire of claim 1 wherein there are a total of three annular rows of sheath wires in the first layer.

11. The pneumatic radial tire of claim 1 wherein there are a total of two annular rows of sheath wires in the first layer.

12. The pneumatic radial tire of claim 1 wherein there are a total of two annular rows of sheath wires in the second layer.

13. The pneumatic radial tire of claim 1 wherein there are two rows of sheath wires in the outer layer.
